(19) United States
(12) Patent Application Publication
(10) Pub. No.: US 2018/0106425 A1
(43) Pub. Date: Apr. 19, 2018

(54) BALANCING SUPPORT INTERFACE FOR PAYLOAD STABILIZERS

(71) Applicant: Garrett W. Brown, Philadelphia, PA (US)

(72) Inventors: Garrett W. Brown, Philadelphia, PA (US); Ty Corey Hargroder, Los Angeles, CA (US); H. Robert Orf, Simi Valley, CA (US)

(73) Assignee: Garrett W. Brown, Philadelphia, PA (US)

(21) Appl. No.: 15/725,373

(22) PCT Filed: Apr. 6, 2016
(86) PCT No.: PCT/US2016/026181

§ 371 Date: Oct. 5, 2017

Related U.S. Application Data
(60) Provisional application No. 62/143,897, filed on Apr. 7, 2015.
(60) Provisional application No. 62/216,552, filed on Sep. 10, 2015.

(51) Int. Cl. F16M 13/04; G03B 17/56; F16M 11/12; F16M 11/20

(52) U.S. Cl. CPC F16M 13/04; G03B 17/563; G03B 17/561; F16M 2200/042; F16M 11/2071; F16M 2200/044; F16M 11/123

(57) ABSTRACT

The disclosed balancing support interface provides an interface between a payload stabilizer, such as a motorized camera stabilizer, and a counterbalancing arm or other support apparatus. A balancing support interface to connect a payload stabilizer to a support structure and provide degrees of freedom to supplement any degrees of freedom provided by the payload stabilizer.

### BACKGROUND

The weight of a motorized stabilizer, such as those used with video cameras, for example, can limit the duration it can be used over a continuous period of time. Mounting the stabilizer to a counterbalancing arm, or other support structure, can extend the time a user can operate the stabilizer. Therefore, it can be advantageous to connect a payload stabilizer to a support apparatus, provided the interface does not unduly diminish the functionality of the payload stabilizer, or enhances the functionality.

### SUMMARY

The disclosed balancing support interface provides an interface between a payload stabilizer, such as a motorized camera stabilizer, and a counterbalancing arm or other support apparatus.

In a disclosed example, the balancing support interface provides axes of rotation to isolate pan and tilt movements. These axes of rotation can supplement those afforded by the stabilizer to which it is attached. The balancing support interface provides a handle attached to the payload stabilizer that is extended to attach to a balancing apparatus. The balancing apparatus facilitates tilt motion to allow the payload to rotate about a tilt axis. The balancing apparatus further facilitates pan motion to allow the payload to pan about a pan axis at the connection to the support structure such as a counterbalancing arm.

### BRIEF DESCRIPTION OF THE DRAWINGS

Examples of the invention are best understood by reading the detailed description in conjunction with the following illustrative drawings of disclosed embodiments.

FIG. 1 depicts an illustrative stabilizer system with a balancing support interface attached thereto.

FIG. 2 depicts a side view of an illustrative counterbalancing arm that can be used with a stabilizer system and connected thereto by a balancing support interface.

FIG. 3 illustrates an example of a mechanism to attach a counterbalancing arm to a balancing support interface.

FIG. 4 depicts an end view of an illustrative balancing support interface.

FIG. 4A depicts an illustrative cross-sectional side view of the balancing support interface of FIG. 3.

FIG. 5 depicts an illustrative cross-sectional side view of a balancing apparatus component of a balancing support interface.

FIG. 6 depicts a perspective transparent view of the attachment of a balancing apparatus to a support member of a balancing support interface.

FIG. 7 shows an illustrative perspective view of a balancing support interface including the attachment of a balancing apparatus component to a support member.

FIGS. 8A and 8B depict perspective views of a balancing interface showing a bracket member aligned with an associated end collar, and the bracket member rotated relative to the associated end collar, respectively.

FIGS. 9A and 9B depict perspective views of a balancing interface showing a bracket member aligned with an associated end collar, and the bracket member rotated relative to the associated end collar, respectively.

FIG. 10 depicts a cross-sectional side view of an adjustable attachment system to connect balancing support interface to a motorized camera stabilizer.

FIG. 11 depicts a further embodiment of a balancing support interface connected to a motorized camera stabilizer.

FIG. 12 depicts an illustrative support vest to which a counterbalancing arm can be attached.

### DETAILED DESCRIPTION

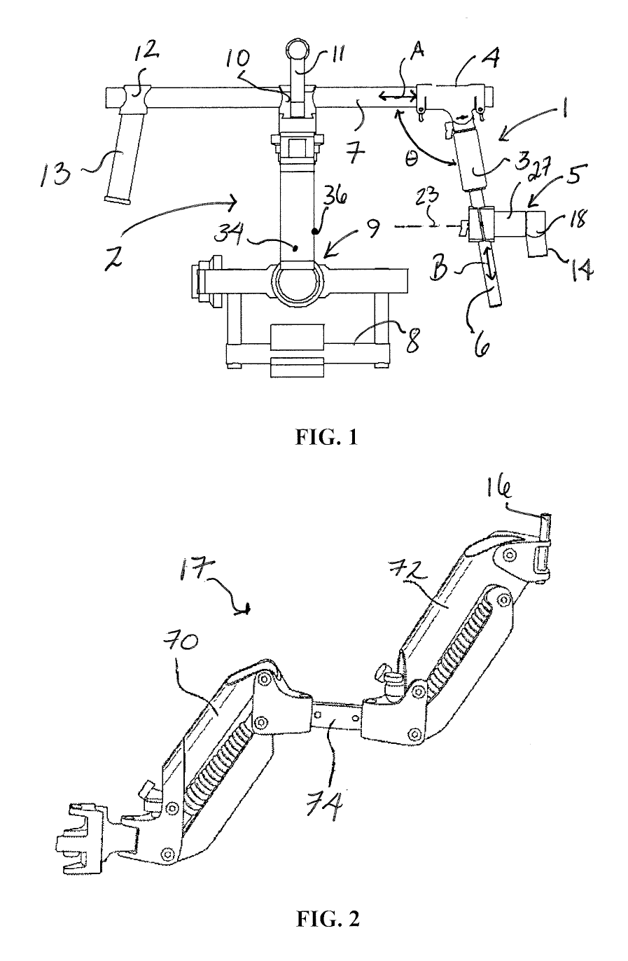

FIG. 1 depicts an illustrative embodiment of a balancing support interface 1 attached to a motorized camera stabilizer 2. Balancing support interface 1 supplements the degrees of freedom offered by a gimbal in motorized camera stabilizer 2. Balancing support interface 1, as depicted in the FIG. 1 example, includes a control handle 3, a handle bracket 4, a balancing apparatus 5, and an interface support member 6.

Control handle 3 is adjustably attached to a motorized stabilizer support member 7 by handle bracket 4. In this illustrative embodiment motorized stabilizer support member 7 can be inserted into handle bracket 4 for attachment of balancing support interface 1 to an existing motorized camera stabilizer 2. Other attachment mechanisms can be used, which may vary based on the motorized camera stabilizer 2 configuration or other payload stabilizer. FIG. 1 depicts an illustrative embodiment of motorized camera stabilizer 2 with a payload platform 8, which may be motorized, to hold a payload such as a camera. Motorized camera stabilizer 2 has a gimbal 9 that provides at least two degrees of freedom, such as about tilt and pan axes, for example. Motorized camera stabilizer 2 is slidably attached to motorized stabilizer support member 7 by a bracket 10 that has a handle 11 extending therefrom.

The angle θ at which control handle 3 is attached to handle bracket 4, and hence the angle to motorized stabilizer support member 7, may be adjustable and lockable in a desired angular position. Furthermore, the lateral position of control handle 3 along motorized stabilizer support member 7 may be adjustable as shown by arrow A. Control handle 3 may be configured to function as a mount for an interface support member 6 to which a balancing apparatus 5 can be attached. Alternatively, handle 3 may extend to a length sufficient to allow balancing apparatus 5 to be attached thereto. Balancing apparatus 5 provides the degrees of freedom that supplement those afforded by motorized camera stabilizer 2, which will be described in more detail below.

Interface support member 6 may be attached to handle 3 by a pin and socket apparatus. Balancing apparatus 5 may be adjustable in the directions of arrow B. Support members 5, 7, may be made, for example, of a carbon fiber. Support members may be solid or hollow and may have various cross-sectional shapes, dictated, at least in part, by the functionality of the support member.

Motorized camera stabilizer 2 may also have a second control handle 13 adjustably attached to motorized stabilizer support member 7, such as by handle bracket 12. Motorized camera stabilizer 2 is adjustably attached to motorized stabilizer support member 7 between balancing support interface 1 and control handle 13, which can each be on either the right or left side of motorized camera platform 3.

Handles 3 and 13 are shown and described as being at opposing ends of motorized stabilizer support member 7, but may be adjusted toward the center of motorized stabilizer support member 7.

Balancing apparatus 5 includes a support mount 14 that may be used, for example, to connect to a counterbalancing arm 17. An illustrative example of a counterbalancing arm 17 that can be attached to balancing support interface 1 at support mount 14 is provided in FIG. 2. Counterbalancing arm 17 may be, for example, an arm sold under the brand STEADICAM®.

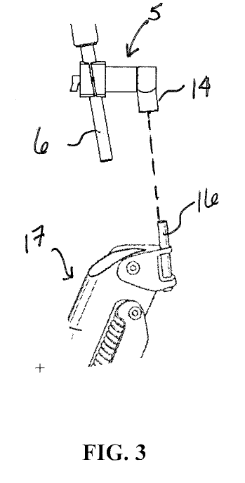

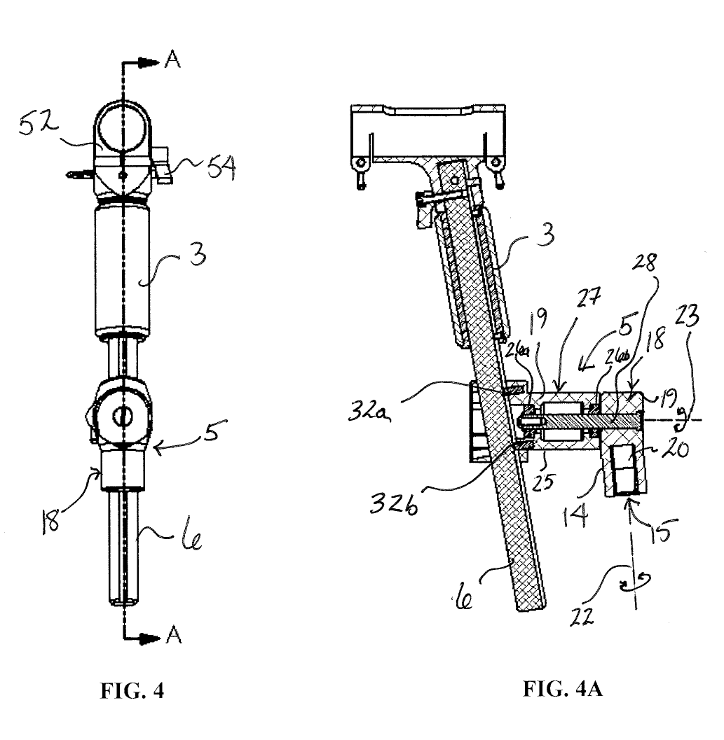

Support mount 14 includes a post receptacle 15. Post receptacle 15 as shown in FIG. 4A, for example, is complementary and engageable with a counterbalancing arm mount post 16 on counterbalancing arm 17. Other counterbalancing arm attachment mechanisms can be used to connect balancing support interface 1 to counterbalancing arm 17 or other objects, provided the connection is sufficient to support the weight of the apparatus and allow the desired mobility. FIG. 3 provides an example of a connection between support mount 14 and counterbalancing arm 17, showing support mount 14 separated from mount post 16.

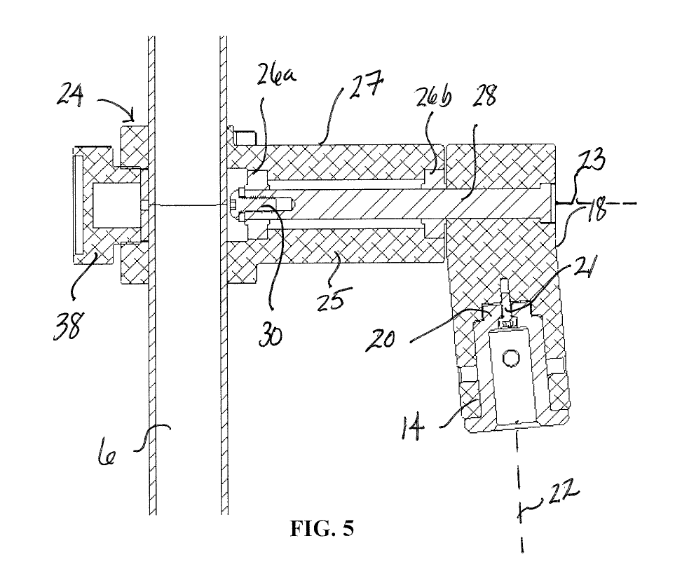

FIG. 4 is an end view of balancing support interface 1. FIG. 4A is a cross-section view taken through line A-A of balancing support interface 1 of FIG. 4. Balancing apparatus 5 includes a pan bearing mount 18. Pan bearing mount 18 contains a pan bearing housing 19. Pan bearing mount 18 has a pan bearing or bushing 20. Pan bearing 20 provides a first degree of rotational freedom, in addition to those provided by motorized camera stabilizer 2. Pan bearing 20 may be attached to pan bearing shaft 21 and rotates about pan bearing axis 22 as shown, for example, in FIG. 5. Pan bearing axis 22 may be offset slightly from vertical. The term “pan axis” is used generally, and is not limited to a strict vertical axis, as will be described in more detail below.

Further included in balancing apparatus 5 is tilt bearing mount 27 having a tilt axis 23. Tilt axis 23 is positioned approximately perpendicular to pan bearing axis 22, providing a second angular degree of freedom.

Tilt bearing mount 27 is attached to interface support member 6 by a post mount clamp 24 or other payload stabilizer connection component. Tilt bearing mount 27 includes a tilt bearing housing 25 with at least one tilt bearing 26. A tilt shaft 28 extends through tilt bearings 26a,b. Two tilt bearings are shown by way of example, but any suitable number of tilt bearings may be included. Similarly, any suitable number of pan bearings may be included in the apparatus. Tilt shaft 28 extends into pan bearing mount 18 and allows tilt bearing housing 25 to rotate about tilt axis 23. If pan bearing axis is offset from vertical, pan bearing axis may not be perpendicular to tilt axis 23, such as shown, for example, in FIG. 5.

Tilt shaft 28 may be secured to tilt bearing mount 27 with a retaining screw 30. One or more alignment pins 32a,b are provided to prevent rotation about tilt bearing mount 27 of interface support member 6 as shown in FIG. 4A.

Support mount 14 is adapted to receive a mount post, such as counterbalancing arm mount post 16, which is attached to a load-bearing end of counterbalancing arm 17. Pan bearing 20 can be made in multiple sizes to accommodate different counterbalancing arms or other mounting methods. It is noted that in embodiments of balancing support interface 1, pan and tilt bearings may be substituted with bushings in some cases.

As noted above, pan bearing axis 22 may be slightly offset from vertical, for example to counteract the cumulative twist that a typically offset payload, such as motorized camera stabilizer 2, would produce by the payload receiving end of a counterbalancing arm 17. This angular offset corrects the counterbalancing arm 17 possible twist angle and may allow motorized stabilizer support member 7 to remain approximately horizontal.

The pan and tilt rotational functionality of the balancing support interface, allows a motorized payload stabilizer to rotate about pan axis 22 and tilt axis 23.

The positioning of the center of gravity of motorized camera stabilizer 2 and balancing support interface 1 is generally important to the operation of the system as a whole. FIG. 1 shows the center of gravity 34 of motorized camera stabilizer 2. The center of gravity of the combined motorized camera stabilizer 2, balancing support interface 1 and a camera is shown at point 36. Center of gravity 36 is horizontally in line or slightly below tilt axis 23. The aforementioned positioning is in reference to tilt axis 23 being roughly horizontal.

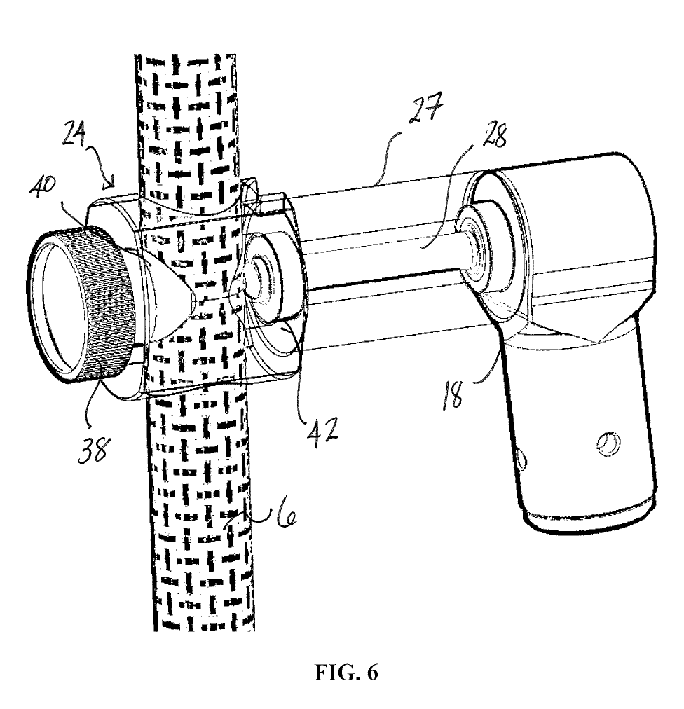

FIG. 5 and FIG. 6 depict balancing apparatus 5. In this illustrative embodiment, interface support member 6 is perpendicular to tilt shaft 28, i.e. tilt axis 23. FIG. 5 is a cross-sectional view of balancing apparatus 5 and FIG. 6 shows a transparent perspective view of balancing apparatus 5. Knob 38 tightens mount clamp 24 around interface support member 6 by drawing clamp sections 40, 42 toward or away from interface support member 6.

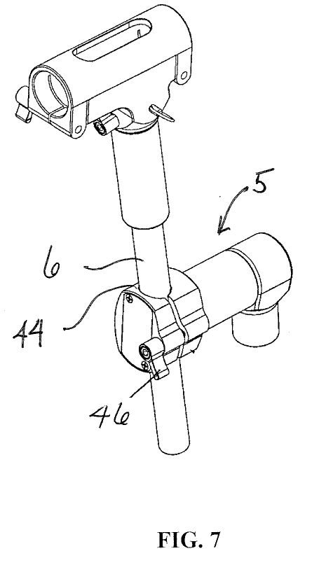

FIG. 7 depicts a perspective view of balancing support interface 1. In this illustrative embodiment, interface support member 6 is secured to balancing apparatus 5 by an interface support member clamp 44. Interface support member clamp 44 is tightened against interface support member 6 by clamp lever 46.

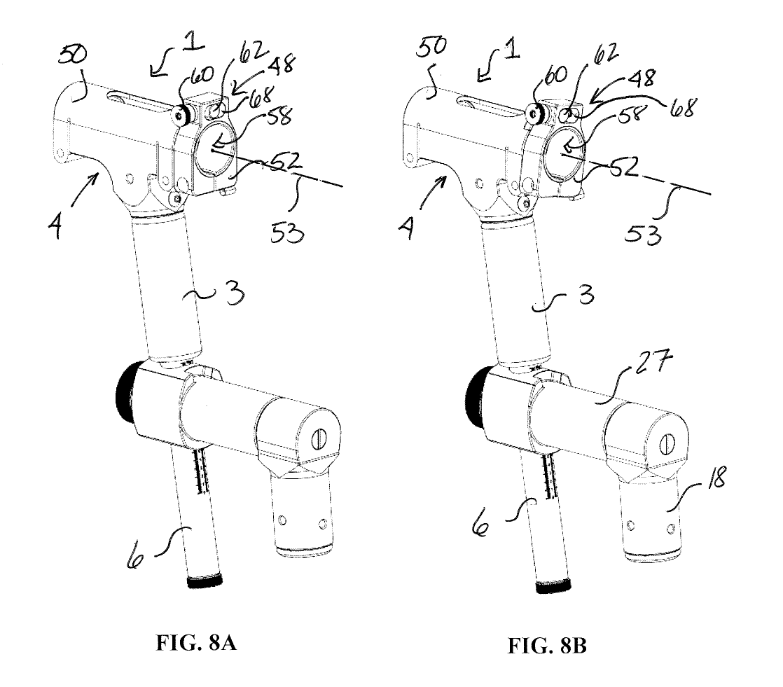

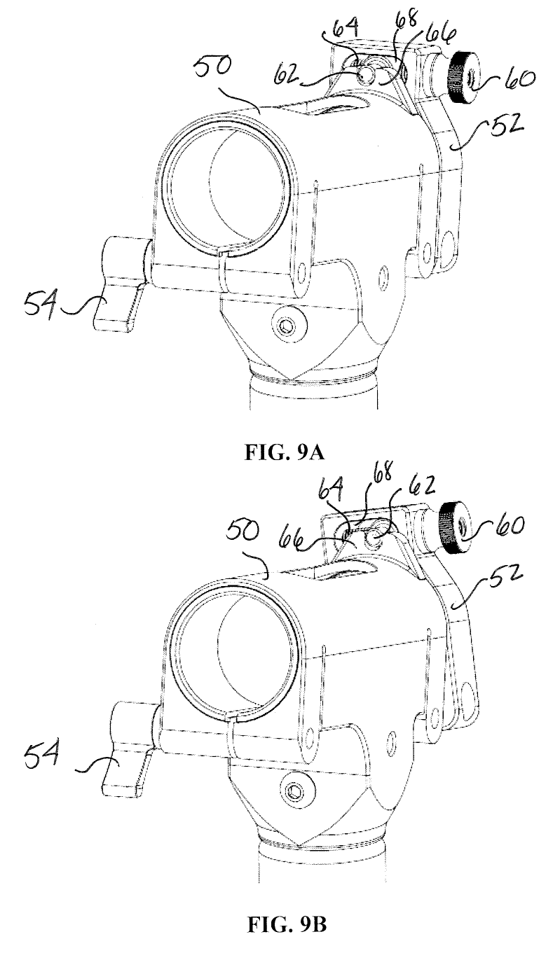

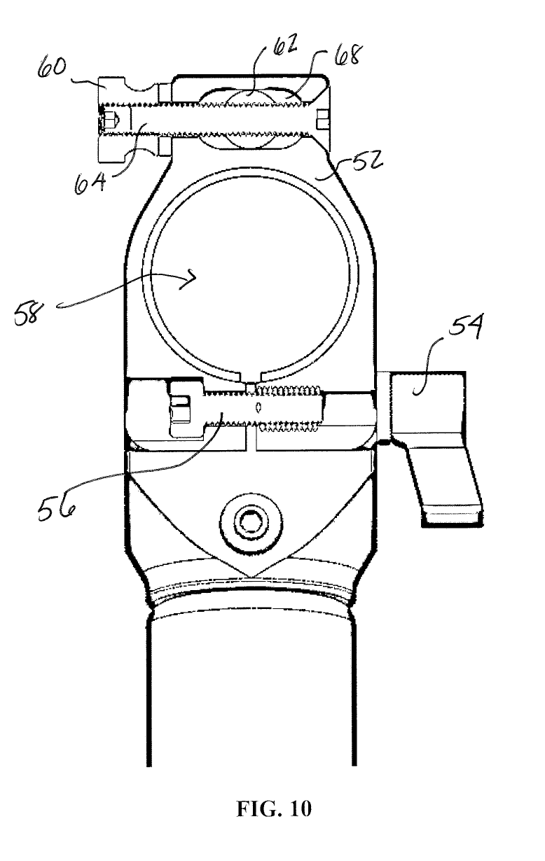

FIGS. 8A, 8B depict perspective views of balancing support interface 1, including an interface securing mechanism 48 to adjustably attach balancing support interface 1 to motorized stabilizer support member 7, the positioning of which is shown in FIG. 1. Interface securing mechanism 48 allows adjustments of the orientation of balancing support interface 1 with respect to the existing motorized camera stabilizer 2. FIGS. 9A, 9B depict additional views of interface securing mechanism 48. FIG. 10 is a cross-sectional end view of interface securing mechanism 48 providing further detail.

Turning to FIGS. 8A, 8B, 9A, 9B, 10 handle bracket 4 has a main handle bracket member 50 and an end collar 52. End collar 52 is rotationally connected to main handle bracket member 50 about axis 53. FIGS. 8A, 9A show main handle bracket member 50 aligned with end collar 52. FIGS. 8B, 9B show main handle bracket member 50 rotated with respect to end collar 52.

End collar 52 has a longitudinal axis coincident with the longitudinal axis of main handle bracket member 50, which is further coincident with rotational axis 53. Handle bracket member 50 is secured to motorized stabilizer support member 7, for example, by clamp screw 56, which is adjusted by clamp lever 54. A locking mechanism may also be included to maintain balancing support interface 1 at a desired position along motorized stabilizer support member 7.

Balancing the combination of balancing support interface 1 and motorized camera stabilizer 2 is achieved, at least in part, by adjusting balancing support interface 1 along motorized stabilizer support member 7. Motorized stabilizer support member 7 is secured within opening 58 in end collar 52 of balancing support interface 1 as depicted in FIGS. 8A, 8B. To adjust the balance, end collar 52 is secured to motorized stabilizer support member 7 using clamp screw 56, allowing no movement between end collar 52 and motorized stabilizer support member 7. Clamp lever(s) 54 are loosened so that main handle bracket member 50 can rotate relative to motorized stabilizer support member 7. Turning a balance adjustment knob 60 moves a balance nut 62 along a screw 64 in end collar 52. Balance nut 62 extends into a flange 66 on main handle bracket member 50 as shown, for example, in FIGS. 9A, 9B. Flange 66 may extend from main handle bracket member 50 or extend from a further main handle member fixedly attached to main handle bracket member 50. An extension of balance nut 62 is engaged with a slot 68 in end collar 52. When balance nut 62 moves along screw 64, main handle bracket 50 rotates relative to end collar 52. Once balance is set as desired, clamp levers 54 are tightened.

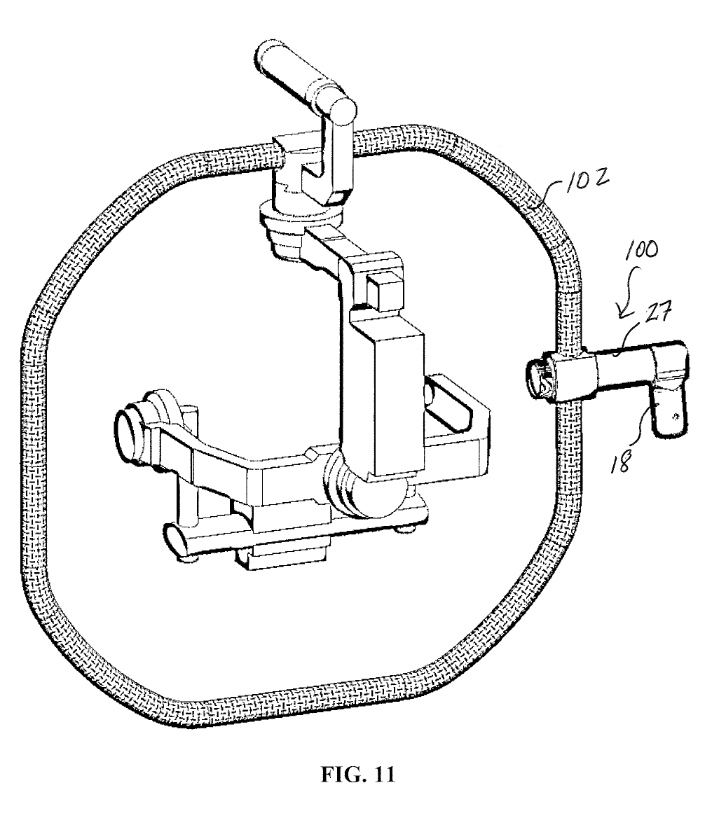

FIG. 11 depicts a further embodiment of a balancing support interface 100. Balancing interface 100 attaches to a payload stabilizer frame 102, shown in FIG. 9 as a ring. Frame 102 may have various shapes that are either open or closed, provided that payload stabilizer frame 102 can support motorized camera stabilizer 2 and balancing support interface 100, and allow for required adjustability of balancing support interface 100 along payload stabilizer frame 102. Exemplary shapes include the shape shown in FIG. 11 circular and rectangular. Shapes may be irregular or symmetrical. Ideally in most cases, payload stabilizer frame 102 should not interfere spatially with operation of motorized camera stabilizer 2 or a counterbalancing arm 17 to which it may be attached.

Payload stabilizer frame 102 is in part a substitute for motorized stabilizer support member 7 and interface support member 6. This also eliminates the need for handle bracket 4 and its associated parts. Balancing support interface 100 thus comprises primarily, the components of counterbalancing arm mount apparatus 5, including, for example, tilt bearing mount 27, pan bearing mount 18 and components to connect balancing support interface 100 to counterbalancing arm 17.

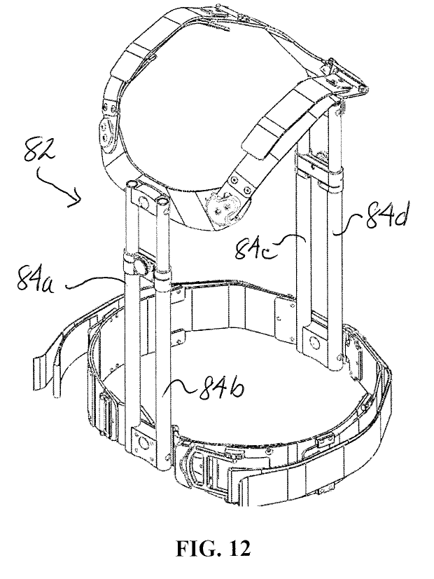

Counterbalancing arm 17 may be a counterbalancing or equipoising arm, and may include hinged segments to form an articulating arm structure. The articulating arm structure may include, for example, one or more counterbalancing links 70, 72 connected by a hinge 74. Counterbalancing arm 17 may be connected to a support vest 82, such as shown in FIG. 12. Vest 82 attaches to counterbalancing arm 17 at an end of counterbalancing arm 17 opposing the attachment to balancing interface 1, 100. Counterbalancing arm 17 may be attached to support vest, for example, to spars 84a,b or 84c,d by a clamping or bracket device.

Illustrative embodiments of the invention may include a camera stabilizer to be used with the balancing support interface. The camera stabilizer may include motors and sensors to control pan, tilt or roll motions, gimbal, camera stage, mechanical and electrical attachment components, support members, and handles, for example. Methods of stabilizing a camera are also included, wherein a balancing support interface 1 according to any of the embodiments disclosed herein is provide. An operator adjusts the position of balancing support interface 1 with respect to motorized camera stabilizer 2, such as along motorized stabilizer support member 7, for example, and also adjust balancing apparatus 5 along interface support member 6, for example, to achieve the desired balance of the combination of motorized camera stabilizer 2, balancing support interface 1 and a camera attached thereto.

It is further balancing support interface 1 can be used with payloads other than motorized cameras, including for example, non-motorized cameras or other payloads that require balancing and control such as provided by a stabilizer device and balancing support interface 1.

Various embodiments of the invention have been described, each having a different combination of elements. The invention is not limited to the specific embodiments disclosed, and may include different combinations of the elements disclosed or omission of some elements and the equivalents of such structures or steps. The invention may also include, in combination with the novel gimbaled interface, elements existing in known camera stabilizers, and counterbalancing arms.

Claimed is:

1. A balancing interface to connect a payload stabilizer apparatus to a support apparatus, the interface comprising:
a payload stabilizer connection component configured to secure the balancing interface to the payload stabilizer apparatus;
a balancing apparatus connected to the payload stabilizer apparatus connection component;
the balancing apparatus having:
a tilt bearing mount;
the tilt bearing mount having a tilt axis about which the payload stabilizer apparatus can rotate;
a pan bearing mount having a pan axis about which the payload stabilizer apparatus can rotate;
the tilt bearing mount having a tilt shaft extending into the pan bearing mount; and
the pan bearing mount having a support mount configured to attach to a support.

2. The interface of claim 1 wherein the balancing apparatus is configured to be further secured to a counterbalancing arm.

3. The interface of claim 1 wherein the payload stabilizer connection component comprises:
a handle bracket configured to be adjustably secured to a payload stabilizer support member;
the handle bracket having:
a main handle bracket member having an interior opening complementary to a cross-sectional shape of the payload stabilizer support member and rotatable with respect to the payload stabilizer support member;
the main handle bracket member adjustable along at least a portion of the length of the payload stabilizer support member;
an end collar having an interior opening complementary to the cross-sectional shape of the payload stabilizer support member and a longitudinal axis coincident with the longitudinal axis of the main handle bracket member;
the end collar securable to the payload stabilizer support member to form a non-rotatable connection; and
the main handle bracket member rotatably connected to the end collar about an axis coincident with the longitudinal axis of the handle bracket.

4. The interface of claim 3 comprising:
an adjustment mechanism for selected rotation of the main handle bracket member with respect to the end collar, wherein the adjustment mechanism includes:
a nut engaged around a screw, the screw disposed within the end collar;
a slot disposed within the end collar;
the nut engaged with the slot; and
a flange extending from the main handle bracket member into which the nut is disposed;
wherein when the nut is moved along the screw the main handle bracket member rotates relative to the end collar.

5. The interface of claim 3 having a handle extending from and adjustably secured to the main handle bracket wherein the balancing apparatus is connected an extension of the handle.

6. The interface of claim 1 wherein the support is a counterbalancing arm and the interface is configured to be connected to the counterbalancing arm.

7. The interface of claim 6 further comprising the counterbalancing arm.

8. The interface of claim 6 wherein the counterbalancing arm is connected to a support vest.

9. A payload stabilizer apparatus comprising:
a motorized payload stabilizer;
a counterbalancing arm; and
an interface according to claim 1 connecting the motorized payload stabilizer to the counterbalancing arm.

10. The interface of claim 1 wherein the balancing apparatus connection component is a clamp configured to connect directly to a support member of the payload stabilizer apparatus.

11. A method of stabilizing a payload comprising:
providing an balancing interface according to claim 1;
attaching the balancing interface to a support member of a payload stabilizer;
attaching the balancing interface further to a support;
adjusting the interface with respect to the support member to achieve a desired balance of the payload stabilizer.
